(19) United States
(12) Patent Application Publication
(10) Pub. No.: US 2009/0178518 A1
(43) Pub. Date: Jul. 16, 2009

(54) HAND OPERATED GRIPPING TOOL

(75) Inventors: Nigel Alexander Buchanan, Fife (GB); Seamus Duffy, Lanesborough (IE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: AMERICAN GREASE STICK COMPANY, Muskegon Heights, MI (US)

(21) Appl. No.: 12/261,525

(22) Filed: Oct. 30, 2008

Related U.S. Application Data
(63) Continuation-in-part of application No. 12/281,548, filed on Sep. 3, 2008.

(30) Foreign Application Priority Data
Mar. 3, 2006 (IE) 2006/0158
Oct. 30, 2007 (GB) 07 21292.1

(51) Int. Cl. B25B 7/14; B25B 7/12

(52) U.S. Cl. 81/324; 81/342

(57) ABSTRACT

A hand operated gripping tool comprises a first jaw unit having a workpiece engaging portion, a second jaw unit having a workpiece engaging portion and being movable relative to the first jaw unit such that a variable size workpiece receiving space is defined between the workpiece engaging portions and a handle for applying a force to the second jaw unit. The second jaw unit is engagable with a reaction surface such that, in use, in response to a force applied by the handle, the workpiece engaging portion is forced against a workpiece received in the workpiece receiving space. An elongate extension portion extends from the workpiece engaging portion. The lever arm is connected with the elongate extension portion and the extension portion has a bend promoting portion disposed between the workpiece engaging portion and the lever arm connection that is configured to promote bending of the extension portion.

### FIELD OF INVENTION

The invention relates to hand operated gripping tools and particularly to hand operated gripping tools that are adjustable to any size of workpiece within the range of the jaws of the tool. One form of hand operated gripping tool to which the invention is particularly applicable is pliers of the type generally referred to as water pump pliers or slip joint pliers.

### BACKGROUND TO THE INVENTION

Existing water pump pliers have the common characteristic of jaws offset at an angle to the pliers' handles and a pivot post, in the form of a bolt or rivet, mounted in the area rearward of the jaw on one of the handles and projecting through an elongate slot on the other handle. In such pliers, means for enabling selective spacing of the distance between the jaws may take the form of spaced apart ridges or teeth provided along the inside long edge of the slot and adapted for incremental selective binding engagement with the pivot post. Another well known way of providing distance adjustment between the jaws in such pliers is to provide spaced apart arcuate ridges on the facing surfaces of the slot for engagement by the pivot post. All such tools require a two-handed operation to adjust the jaw spacing the size of a workpiece to be gripped between the jaws. This adjustment involves pulling the handles apart to permit the pivot post to slide along the slot to move the movable one of the jaws to a position that provides a jaw spacing approximating to the size of the workpiece that is to be gripped.

Other known types of pliers are adapted to slideably close upon a workpiece in response to manual closing of the handles and, in response to contact with the workpiece, automatically lock against further sliding action by engaging suitable teeth and thereby shift from a sliding to a pivoting mode whereby continued exertion of manual force on the handles increases the gripping action upon the workpiece.

The gripping action of the known pliers is a function of the relationship between the length of the operating handles and the length of the jaws from the pivot post, which is typically in a ratio of around 5:1. The result is that a considerable portion of the torque applied to the operating handles is required to grip the workpiece, meaning there is often insufficient torque available to shift a tight workpiece.

In certain circumstances it would be a considerable advantage to be able to lock pliers upon a workpiece. The known pliers are unable to include this function.

Another drawback of the known pliers is that the pivot post fixing action, whether by spaced apart ridges, teeth or arcuate ridges in the slot, is such that the jaws/handles are seldom in an optimum position prior to the shift from sliding to a pivoting mode. This results in a variable gripping action upon the workpiece.

### SUMMARY OF THE INVENTION

The invention provides a hand operated gripping tool comprising a first jaw unit having a workpiece engaging portion, a second jaw unit having a workpiece engaging portion and movable relative to said first jaw unit such that a variable size workpiece receiving space is defined between said workpiece engaging portions and a handle for applying a force to said second jaw unit, said second jaw unit being engageable with a reaction surface such that, in use, in response to said force applied by said handle the workpiece engaging portion thereof is forced against a workpiece received in said workpiece receiving space and comprising an elongate extension portion extending from said workpiece engaging portion, said lever arm being connected with said elongate extension portion at a connection location and said extension portion having a bend promoting portion disposed between said workpiece engaging portion and said connection location which bend promoting portion is configured to promote limited bending of the extension portion in a direction away from said first jaw unit in response to a reaction force generated by engagement with the workpiece between said first and second jaw units.

The invention also includes a hand operated gripping tool comprising a first jaw unit, a second jaw unit, a first cam associated with said first jaw unit, a pivotal handle for applying an operating force to said first jaw unit and a second cam associated with said pivotal handle, said first and second jaw units being cooperable to define a variable size space for receiving a workpiece and said first and second cams being operable in response to an operating force to cause said first and second jaw units to grip the workpiece that is positioned in said variable size space, at least one of said first and second jaw units comprising a flexure promoting portion configured to promote flexure of the jaw unit away from said variable size space in response to a reaction force generated by the workpiece gripped between said first and second jaw units in said variable size space.

The invention also includes a hand operated gripping tool comprising a first jaw, a second jaw cooperable with said first jaw to define a variable size workpiece receiving space, a support on which said first jaw is slideable for varying the size of said workpiece receiving space and a pivotable lever, said first jaw and said pivotable lever each being provided with engagement portions for engaging respective parts on said support such that pivoting movement of said lever in one direction causes said first jaw to move against a workpiece that is positioned in said workpiece receiving space at least substantially in contact with said first and second jaws so as to grip the workpiece and said first jaw being configured to permit limited bending movement away from said workpiece receiving space in response to a reaction force generated by the workpiece gripped between said first and second jaw unit in said workpiece receiving space.

### BRIEF DESCRIPTION OF THE DRAWINGS

In order that the invention may be well understood, some embodiments thereof, which are given by way of example only with reference to the drawings in which:

FIG. 1 shows a first embodiment of a hand operated gripping tool with certain laminations removed and an automatic locking device of the tool in an operative, but unlocked condition;

FIG. 2 shows the first embodiment with certain laminations removed and the automatic locking device in a locking condition;

FIG. 3 shows the first embodiment with certain laminations removed and the automatic locking device in withdrawn non-operative condition;

FIG. 4 is an enlargement of a portion of FIG. 3 showing a movable jaw unit in greater detail;

FIG. 5 shows a second embodiment of a hand operated gripping tool gripping a fastener-type workpiece with a lamination of a jaw unit removed to reveal internal parts of the tool;

FIG. 6 shows a third embodiment of a hand operated gripping tool in a relaxed open condition loosely holding a fastener-type workpiece with a lamination of a jaw unit removed to reveal internal parts of the tool;

FIG. 7 shows the third embodiment in a locked condition with a top lamination of a link arm removed in order to reveal the internal parts of the tool;

FIG. 8 shows a fourth embodiment of a hand operated gripping tool clamping two plates together and with a link member removed to reveal internal parts of the tool;

FIG. 9 shows a fifth embodiment of a hand operated gripping tool with link member removed in order to reveal internal parts of the tool;

FIG. 10 shows the fifth embodiment partially operated with its jaw units coming against a workpiece;

FIG. 11 shows the fifth embodiment in another operating position and gripping a different workpiece;

FIG. 12 shows a sixth embodiment of a hand operated gripping tool opened to receive a fastener and with a link member removed to reveal internal parts of the tool; and

FIG. 13 is a view of the sixth embodiment corresponding to FIG. 12 but showing the tool clamped onto a workpiece.

### DETAILED DESCRIPTION OF THE ILLUSTRATED EMBODIMENTS

In the following description of the illustrated embodiments of a hand operated gripping tool, like parts of the tool will be referred to by the same reference numbers.

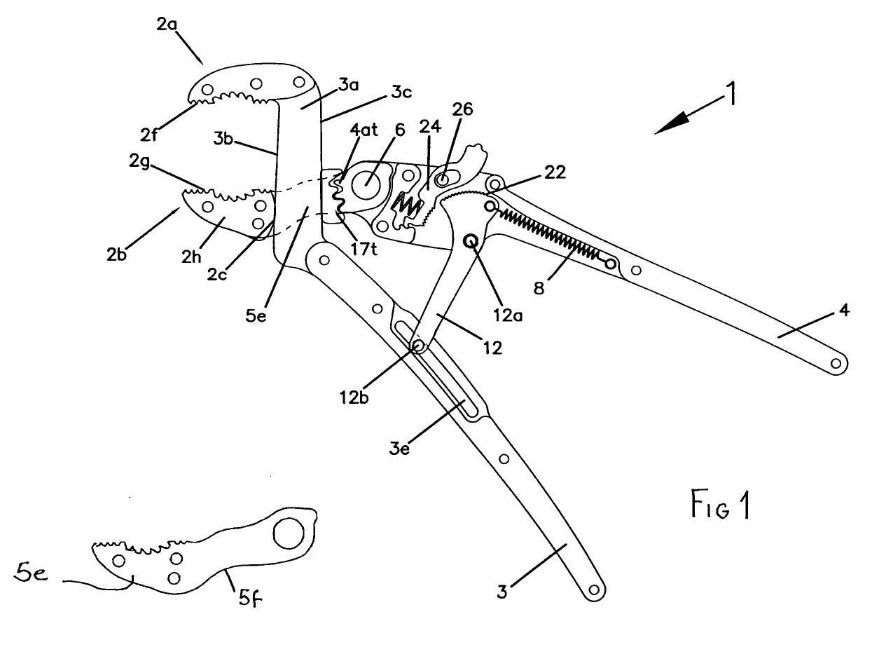

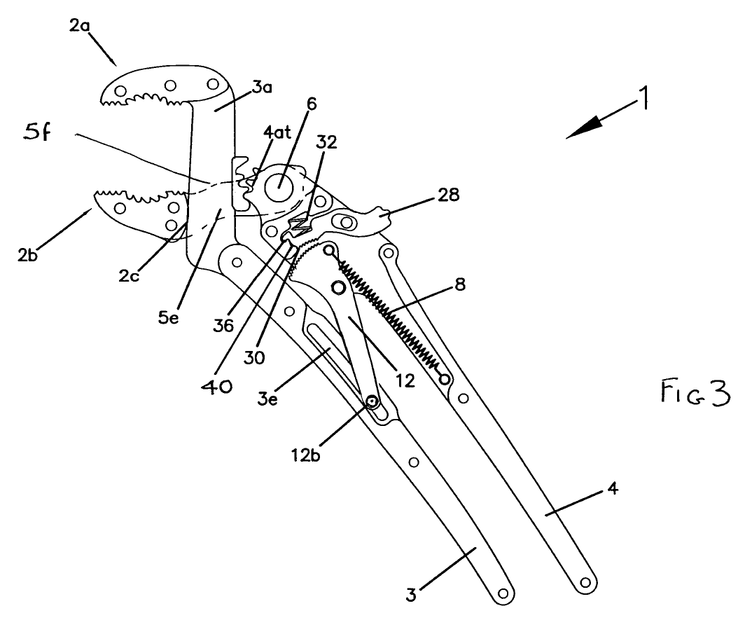

FIGS. 1 to 4 illustrate a first embodiment of a hand operated gripping tool in the form of pliers 1. The pliers 1 comprise a fixed jaw unit 2a, a movable jaw unit 2b, a fixed handle 3 and a pivotal handle 4. Each jaw unit 2a, 2b has a workpiece engaging portion provided with jaw gripping profiles 2g, 2f. The movable jaw unit 2b can be moved relative to the fixed jaw unit 2a by operation of the pivotal handle 4 to provide a variable size workpiece receiving space between the jaw gripping profiles 2g, 2f. The jaw units 2a, 2b, fixed handle 3 and pivotal handle 4 can be laminate structures. In FIGS. 1 to 4, the uppermost (as viewed in the drawings) laminations have been removed to reveal internal features of the pliers 1.

The fixed jaw unit 2a is connected with a support member 3a for the movable jaw 2b. The support member 3a extends transverse to the fixed jaw unit 2a (in this embodiment the jaw support member extends approximately perpendicular to the fixed jaw unit). The movable jaw unit 2b is able to slide along the support member 3a to vary the size of the workpiece receiving space. The support member 3a defines a first clamp, or reaction surface 3b and a second clamp, or reaction surface 3c. The first and second clamp surfaces 3b, 3c are disposed in oppositely facing spaced apart relation. The fixed handle 3 is connected with an end of the support member 3a such that the support member extends between and connects the fixed handle 3 to the fixed jaw unit 2a.

The movable jaw unit 2b is a laminate structure comprising a jaw center member 2h and an extension portion comprising two elongate link members 5e. In FIGS. 1 to 3, the uppermost link member 5e (as viewed in the drawings) has been removed to reveal internal features of the pliers 1. The movable jaw unit 2b comprises a cam surface 2c, which is defined by the jaw center member 2h and is engageable with the first clamp surface 3b. The link members 5e are attached to the sides of a jaw center member 2h such that the jaw center member is sandwiched between the link members. The portions of the link members 5e that are attached against the sides of the jaw center member 2h are shaped to correspond to the profile of the jaw center member and so include jaw gripping profiles 2f, 2g. The link members 5e extend from the jaw center member 2h and are disposed in opposed spaced apart relation to define a gap therebetween. The support member 3a extends through the gap defined between the link members 5e. A pivotal handle 4 is pivotally connected with movable jaw unit 2b by means of a pivot pin 6 at a connection location adjacent the respective free ends of the link members 5e.

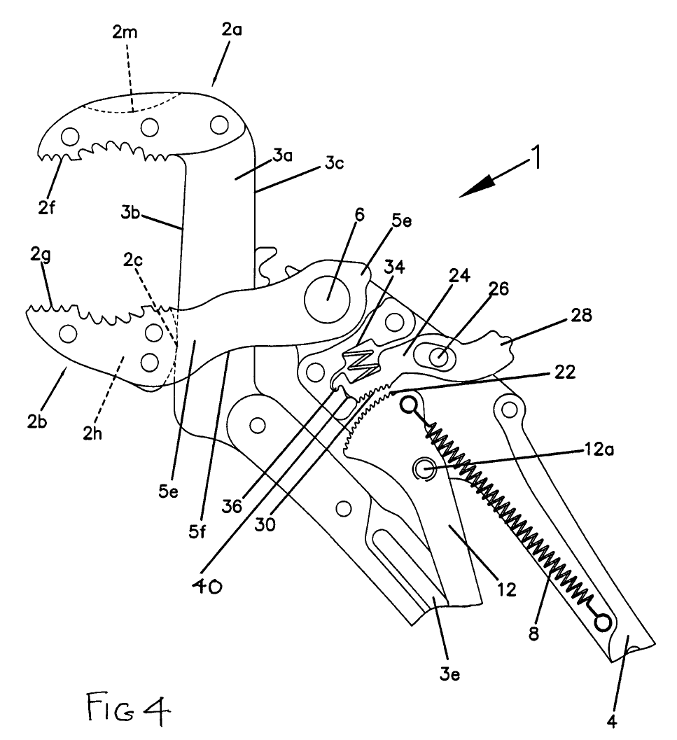

As best seen in FIG. 4, the link members 5e comprise a bend, or flexure, promoting portion 5f. When the movable jaw unit 2b is assembled to the support member 3a, the bend promoting portion 5f is disposed between the first clamp surface 3b and the connection location at which the pivotable handle 4 is connected to the movable jaw unit 2b by the pivot pin 6. Specifically, in the illustrated embodiment the bend promoting portion 5f extends between the cam surface 2c and second clamp surface 3c. The bend promoting portion 5f comprises a bowed, or corrugated, section that is bowed in the general direction of the fixed jaw unit 2a. The bowing is in the plane of the link members 5e.

As best seen in FIG. 1, the pivotal handle 4 is provided with a toothed pivotal handle cam 4 at, which is positioned on the pivotal handle adjacent the pivot pin 6 such that when the pivotal handle pivots on the pivot pin, the cam 4 at pivots about the axis of the pivot pin. The teeth of the toothed pivotal handle cam 4 at engage a toothed slip shoe 17t that engages and is slideable along the second clamp surface 3c.

A pivotal link 12 extends between the fixed handle 3 and pivotal handle 4. The pivotal link 12 is pivotally connected to the fixed handle 3 by a pivot pin 12b that is slideably received in a slot 3e defined in the fixed handle 3. The slot 3c extends in the lengthways direction of the fixed handle 3 and when the uppermost (as viewed in the drawing) lamination of the handle is in place, cannot be seen. The pivotal link 12 is pivotally connected to the pivotal handle 4 by a pivot pin 12a. A biasing member in the form of a tension spring 8 is connected to the pivot pin 12a and a location on the pivotal handle 4 and is arranged to bias the pivotal handle to the position shown in FIG. 1. In FIG. 1, the pliers are shown in a fully open condition in which the workpiece receiving space defined between the jaw units 2a, 2b is at its maximum extent.

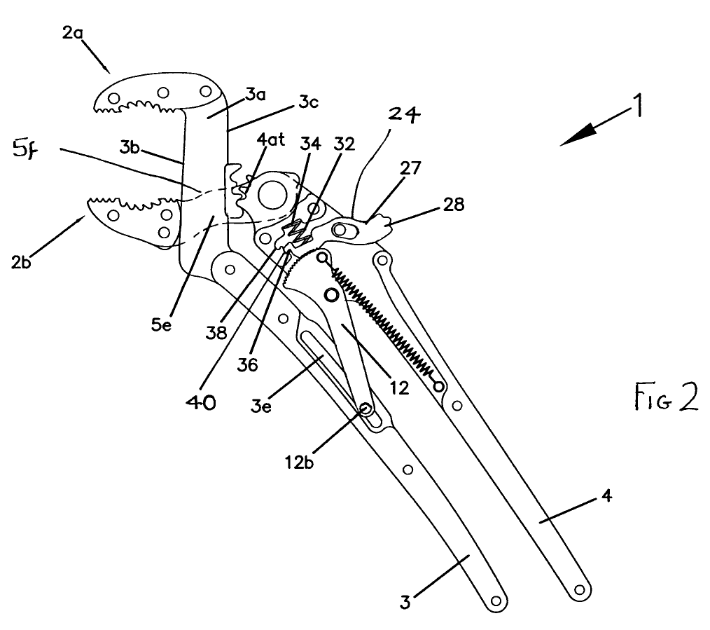

The pliers 1 are provided with an automatic locking device that comprises teeth 22 provided on the end of the pivotal link 12 adjacent the pivot pin 12a and a locking member 24. The locking member 24 is pivotally mounted on the pivotal handle 4 on a pivot pin 26. The pivot pin 26 is fixed to the pivotal handle 4 and extends through a lengthways extending slot 27 (FIG. 2) provided in the locking member 24. The locking member 24 has a thumb tab 28 for actuation by a user of the pliers 1. When the uppermost lamination of the pivotal handle 4 is in place, the thumb tab 28 is the only portion of the locking member 24 that is visible.

Referring particularly to FIGS. 2 and 4, at the end of the locking member 24 opposite the thumb tab 28, the side of the member facing away from the pivotal handle pin 6 is provided with teeth 30 for engaging the teeth 22 on the pivotal link 12. On the other side of the locking member 24 opposite the teeth 30, there is a recess that houses an end of a resilient member, which in this embodiment is compression spring 32. The opposite end of compression spring 32 is held in a recess 34 provided in the pivotal handle 4. As best seen in FIG. 4, the toothed end of the locking member 24 is provided with a nose-like projection 36 that engages in recesses 38, 40 provided in the pivotal handle 4 to locate the locking member 24 in its inoperative and operative positions respectively. The compression spring 32 biases the locking member 24 to the operative position shown in FIGS. 1 and 2 in which the projection 36 engages in the recess 40 and the member is able to automatically engage the teeth 22 provided on the end of the pivotal link 12. When the projection 36 is engaged in the recess 38, the locking member is held in a withdrawn position in which it cannot engage with the pivotal link 12. Thus, the locking member 24 can be locked in a withdrawn inoperative position. This means that, when desired, the pliers 1 can be used without the automatic locking device. When a user wishes to activate the automatic locking device, the thumb tab 28 is used to slide the locking member 24 outwardly with respect to the pivotal handle 4 to withdraw the projection 36 from the recess 38. Once the projection 36 is clear of the recess 38, the compression spring 32 acts against the toothed end of the locking member to move the locking member to the operative position shown in FIGS. 1 and 2 in which it is ready to automatically engage the pivotal link 12.

In FIG. 2, the teeth 30 on the locking member 24 are shown engaging the teeth 22 on the pivotal link 12, thereby locking the jaw units 2a, 2b in the position shown. The teeth 22, 30 are shaped such that as the pivotal link 12 pivots from the position shown in FIG. 1 to the position shown in FIG. 2, they automatically engage in the manner of a ratchet. The biasing force provided by the compression spring 32 presses the teeth 30 into the teeth 22, thereby ensuring that locking engagement is maintained.

The lock can be released by pushing down (as viewed in FIG. 2) on the thumb tab 28 to cause the toothed end of the locking member 24 to pivot clockwise to release the pivotal link 12 and allow free movement of the pivotal handle 4 relative to the fixed handle 3. When the thumb tab 28 is released, the toothed end of the locking member 24 is returned to the position shown in FIG. 1 so that the locking member is ready to automatically engage the teeth 22 of the pivotal link 12.

The bend or flexure promoting portion 5f has been found to provide advantages in the operation of the pliers 1. It will be appreciated that when the movable jaw unit 2b engages a workpiece trapped between the jaw gripping profiles 2f, 2g, it can require a considerable force input from the user to force the moveable jaw unit 2b hard into the workpiece so that the teeth 22 on the pivotal link 12 fully engage the teeth 30 on the locking member 24. This is particularly so if the jaw units 2a, 2b and workpiece are made of a hard material and are rigid. Where the respective parts are hard and rigid, there is a risk of the teeth 22, 30 not fully engaging and the lock slipping. By providing a limited flexure, or bending, of the workpiece engaging portion of the movable jaw unit 2b away from the workpiece, as additional force is applied to the pivotal handle 4 by the user, sufficient additional movement of the handle is available to ensure full engagement of the teeth 22, 30. This makes achieving locking easier for the user and reduces the stresses on the movable jaw.

Referring to FIG. 4, an optional recess, or cut-out, 2m is shown provided in the fixed jaw unit 2a. This allows additional flexure of the jaw units 2a, 2b to further reduce the user input force needed to lock the jaw units 2a, 2b in firm engagement with a workpiece.

It will be appreciated that the configuration of the bend promoting portion 5f and, when provided, the recess 2m can be varied considerably to provide the degree of flexure required. For example, the bend promoting portion of 5f comprises a single bow or arch directed in the general direction of the workpiece receiving space. It is envisaged that further arches, undulations or corrugations in the plane of the link members 5e could by provided. It will also be appreciated that the degree of allowed bending should be relatively small; otherwise, the pliers 1 will not be able to provide a satisfactory gripping action. The degree of flexure required and allowable for satisfactory operation on the pliers 1 can readily be determined by experiment.

Optionally, the first and second clamp surfaces 3b, 3c provided on the support member 3a are not parallel. Instead, the first clamp surface 3b tapers towards the second clamp surface 3c as the two surfaces approach the fixed jaw 2a. This tapering of the support member 3a is shown in FIG. 4. The wedge effect this provides causes the movable jaw unit cam 2c to act more quickly and to lock better. This also allows the jaw angle to be less likely to result in a partial closure when gripping a thin workpiece as the thinning of the support member 3a towards the fixed jaw unit 2a can cancel out the effect of any rotation of the toothed pivotal handle cam 4 at against the toothed shoe 17.

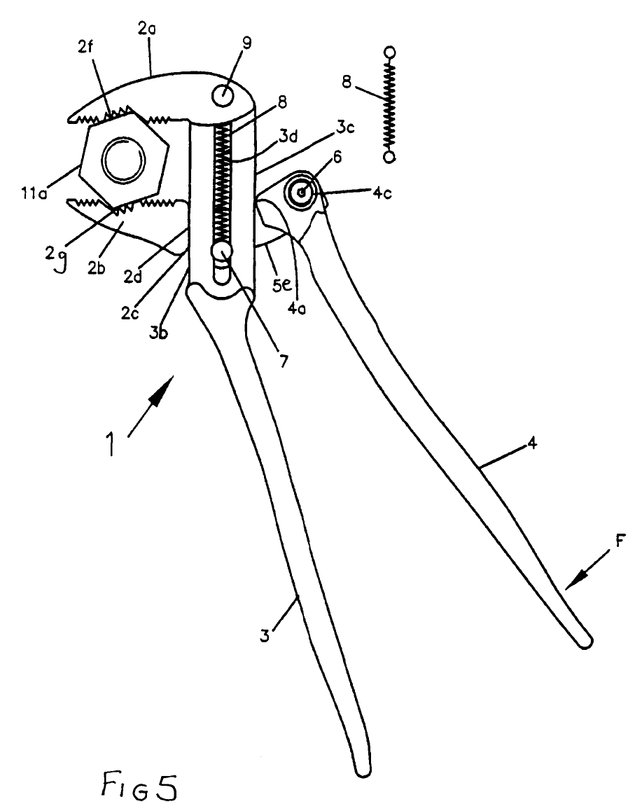

FIG. 5 illustrates a second embodiment of a hand operated gripping tool in the form of pliers 1. The pliers 1 are shown in a closed condition gripping a fastener-type workpiece between the jaw units 2a, 2b. The uppermost (as viewed in the drawing) link member 5e has been omitted to reveal internal parts of the pliers 1.

In the second embodiment, the support member 3a extends generally perpendicular to the first jaw unit 2a and has first and second clamp surfaces 3b, 3c that are disposed in substantially parallel spaced apart relation. A slot 3d extends in the lengthways direction of the support member 3a. A slide pin 7 extends through the slot 3d generally perpendicular to the plane of the support member 3a and is held in respective bushes provided in the link members 5e. The slide pin 7 is able to slide along the slot 3d as the second jaw unit 2b slides along the support member 3a. A resilient member in the form of a tension spring 8 is housed within the slot 3d. One end of the spring 8 is secured to the fixed jaw 2a by a spring post 9. The opposite end of the resilient member 8 is secured to the slide pin 7. The spring 8 pulls the second jaw unit 2b towards the first jaw unit 2a such that that pliers 1 are biased towards a closed condition and will provide a light clamping force on the workpiece 11a prior the application a force F to the pivotal handle 4.

The pivotal handle 4 is provided with an integral cam 4a that acts against the second clamp surface 3c of the support member 3a to cause rotation of the cam 2c of the second jaw unit 2b against the first clamp surface 3b. The pivotal arm 4 is also provided with respective stop surfaces 4d arranged to be engageable with stops 5d that project from the link members 5e and serve to limit movement of the pivotal handle 4 away from the fixed handle 3.

There now follows a description of five further embodiments of a hand operated gripping tool in the form of pliers 1 that in each case comprise a bend, or flexure, promoting feature in one or both of the two jaw units. These embodiments show how the flexure promoting concept can be incorporated into various configurations of hand operated gripping tool and the description of them will provide further illustration of the functioning of the first embodiment.

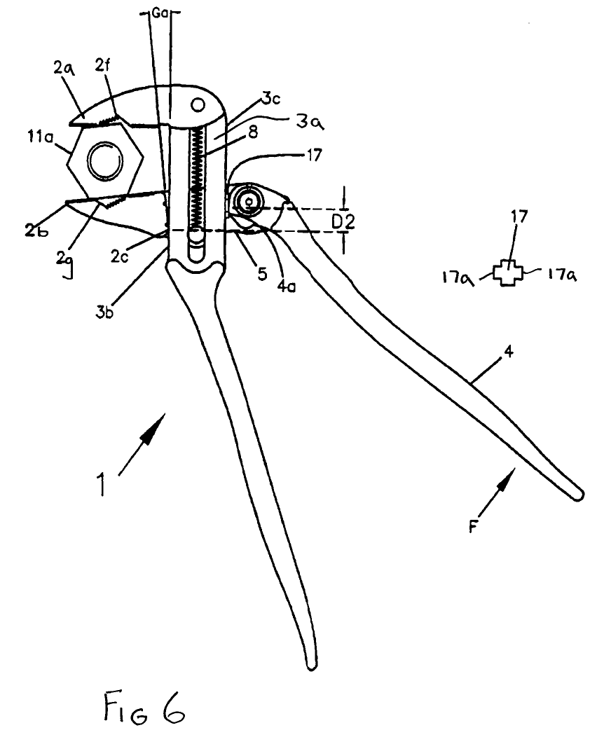

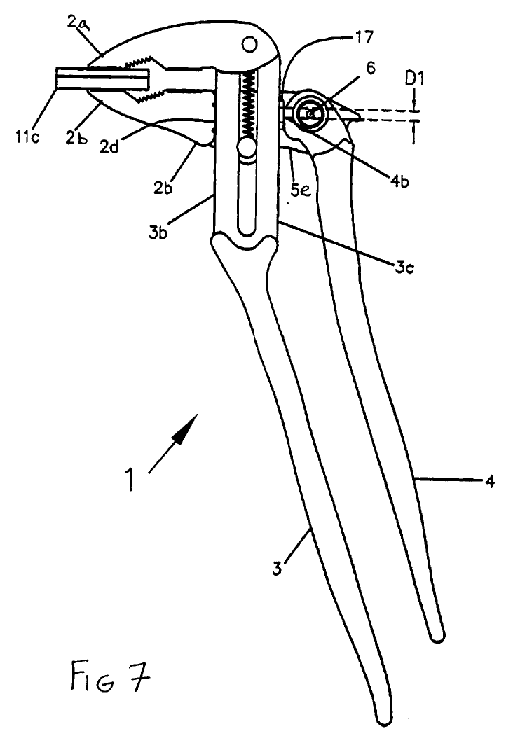

FIGS. 6 and 7 show a third embodiment of a hand operated gripping tool in the form of pliers 1 with the uppermost (as viewed in the drawing) link arm 5e removed in order to show internal parts of the tool.

In FIG. 6, the pivotal handle 4 is shown in a fully opened position. In this position the cam 4a on the pivotal handle 4 has been moved out of engagement with the slip shoe 17 and the cam surface 2c is spaced from the first clamp surface 3b (see the gap Ga). In this condition of the pliers 1, it is only necessary to overcome the tension of the resilient member 8 in order to rotate the jaw units 4a, 4b to allow the jaw gripping profiles 2e, 2f to be repositioned upon the workpiece 11a.

The slip shoe 17 is shown to be in the form of a cross. The slip shoe 17 is held between the cam 4a on the pivotal handle 4 and the second clamp surface 3c by the arms 17a of the slip shoe engaging in respective slots (not shown) in the link members 5e. The slip shoe 17 is thus constrained to move with the movable jaw unit 2b as it slides on the support member 3a.

The cam-to-cam distance D2 between the cams 4a, 2c is indicated.

FIG. 7 shows the third embodiment with the pivotal handle in the fully closed position and the jaws units 2a, 2b clamping a workpiece 11c in the form of two plate-like members. The movement of the pivotal handle 4 to the fully closed position has rotated the cam 4a past the slip shoe to bring a locking surface 4b has into firm contact with the second clamp surface 3c via the slip shoe 17. The operation of the clamp 4a on the pivotal handle has moved the movable jaw unit 2b on the cam surface 2c to bring a locking portion 2d of the movable jaw unit 2b into engagement with the first clamp surface 3b above the center of the pivot pin 6 a distance D1. This arrangement prevents the pivotal handle 4 from moving outwards with respect to the fixed handle 3 unless manually moved in that way. This locks the pliers 1 in the closed position gripping the workpiece 11c.

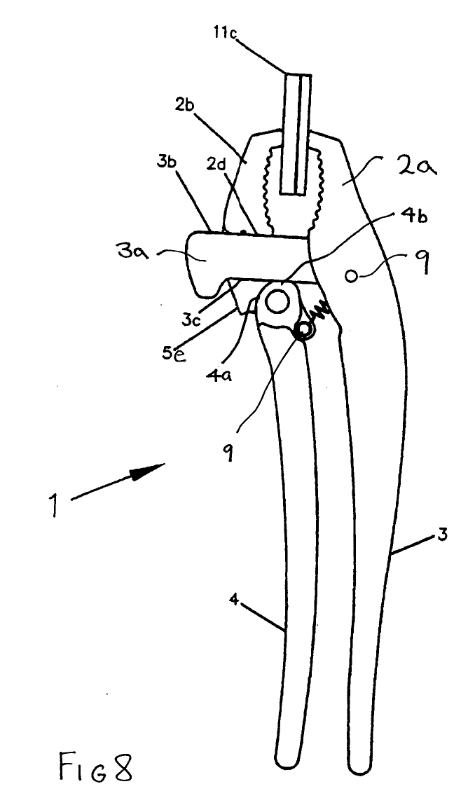

FIG. 8 is a plan view of the fourth embodiment of a hand operated gripping tool in the form of pliers 1. Again, an uppermost (as viewed in the drawing) link member 5e of the movable jaw unit 2b has been omitted to show internal features of the pliers 1.

In this embodiment the fixed handle 3 is joined directly to the fixed jaw unit 2a. The resilient member 8 is not within an elongate slot in the support arm 3a. Instead, it is held between respective spring posts 9 fitted to the fixed jaw unit 2a and movable jaw unit 2b. The resilient member 8 is arranged to bias the movable jaw unit 2b towards the fixed jaw unit 2a and position the cam 4a on the pivotal handle 4 against the second clamp surface 3c when the pliers 1 is in a rest position. In this embodiment, there is no slip shoe, so the cam 4a bears directly against the second clamp surface 3c.

In FIG. 8, the pivotal handle 4 is shown moved fully towards the fixed handle 3, resulting in a locking portion 4b of the pivotal handle 4 being brought into full contact with the second clamp surface 3c so that the jaw units 2a, 2b are clamped onto the workpiece 11c.

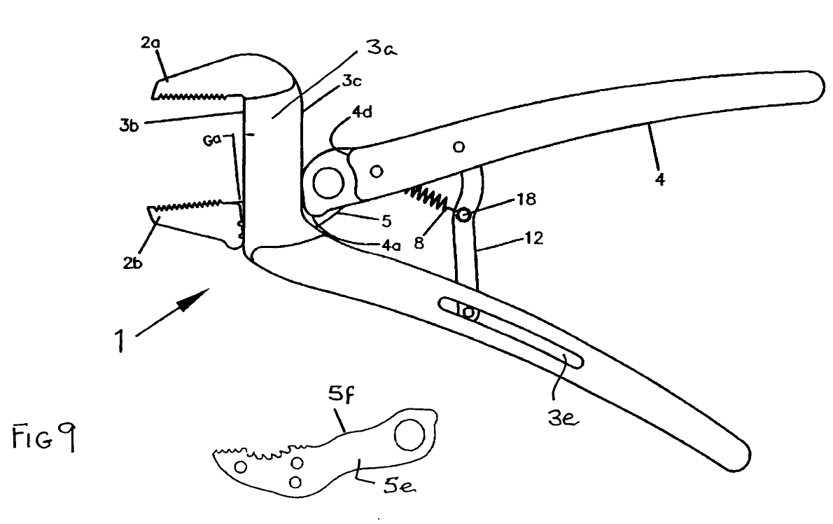

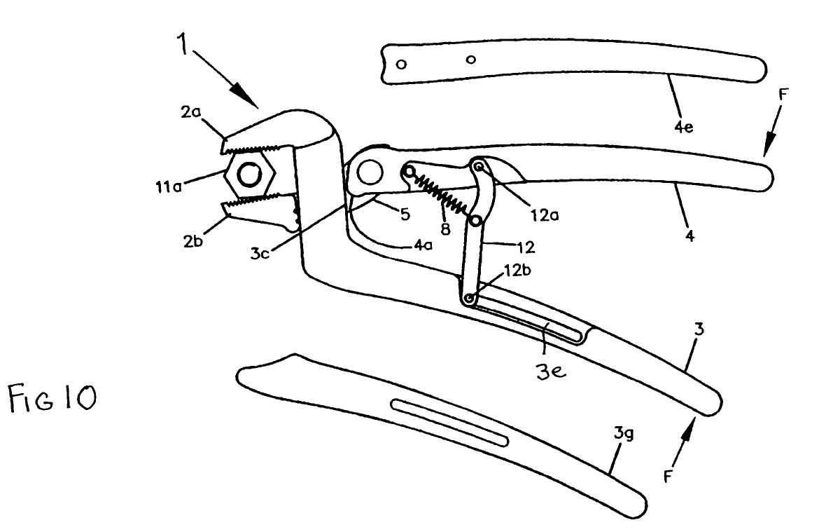

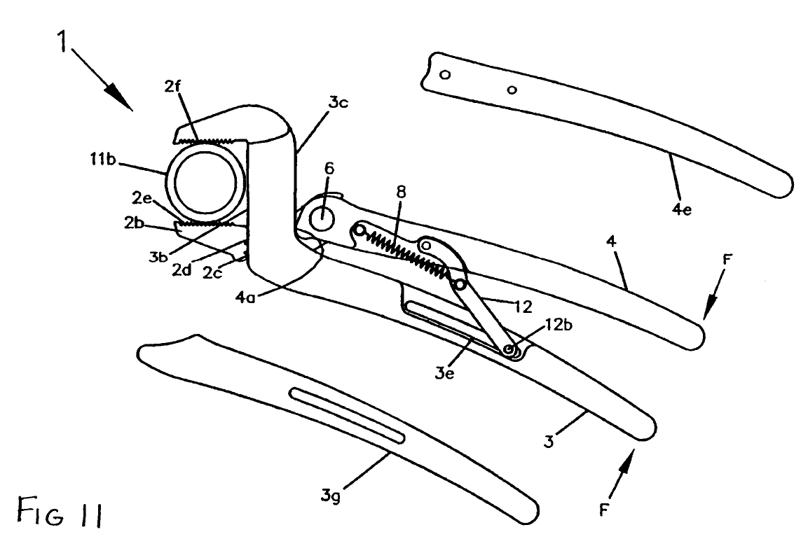

FIGS. 9 to 11 show a fifth embodiment of a hand operated gripping tool in the form of pliers 1. In FIGS. 10 and 11 the fixed handle top laminate 3g, pivotal handle top laminate 4e and top link member 5e are shown removed.

In FIG. 9 the pliers 1 are shown at rest. The resilient member 8 is acting on the pivotal handle 4 and pivotal link 12 to urge the movable jaw unit 4b down the support member 3a away from the fixed jaw unit 2a. This moves the cam surface 2c off the first clamp surface 3b to open a gap Ga. A stop 4d on the pivotal handle 4 acts against a stop 5d on the link member 5e to limit the movement of the pivotal handle. The cam 4a on the pivotal handle 4 is off of the second clamp surface 3c.

In FIG. 10 the pivotal handle 4 is shown pushed towards the fixed handle 3 by a force F that causes it to pivot around the pivotal link 12 against the resistance of the resilient member 8 until the movement is arrested by the jaw units 2a, 2b coming against a workpiece 11a. During this part of the movement the initial engagement of the cam 4a on the pivotal handle 4 with the second clamp surface 3c causes no effective clamping action on the fastener 11a.

In FIG. 11 the pivotal handle 4 and pivotal links are shown in a fully operated position causing the jaw units 2a, 2b to clamp on a tubular workpiece 11b. The force F applied to the pivotal handle 4 has caused the pivot pin 12b to travel down the slot 3e in the fixed handle 3, thereby extending the resilient member 8. This allows the pivotal handle 4 to rotate around the pivot pin 6 causing the cam 4a on the pivotal handle to act on the second clamp surface 3e. This action rotates the movable jaw unit 2b on the cam surface 2c driving the locking portion 2d towards the first clamp surface 3b further improving the gripping action of the jaw units 2a, 2b on the workpiece 11b. This allows considerable torque to be applied to the rotation of the workpiece 11b, whilst a reduced force F is required to ensure the jaw units 2a, 2b continue to grip the workpiece 11b.

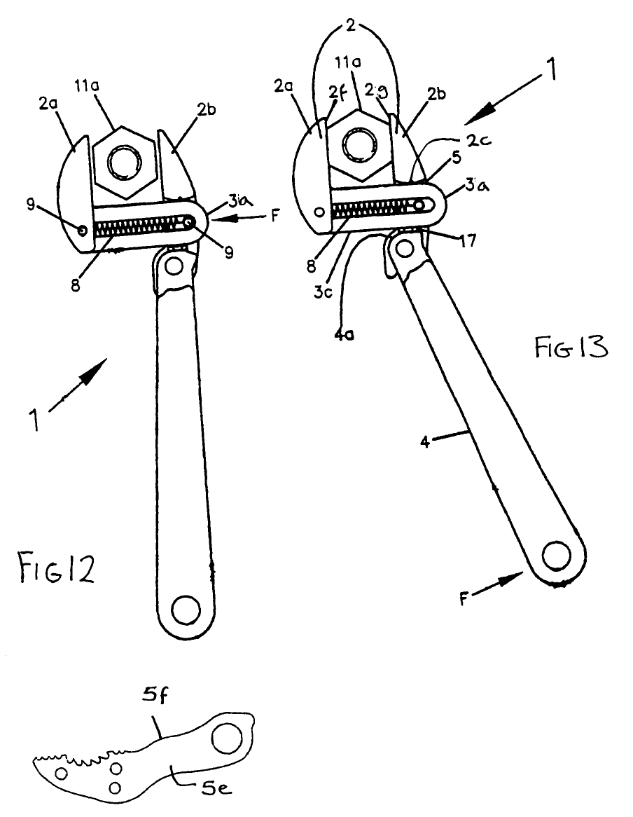

FIGS. 12 and 13 illustrate a sixth embodiment of a hand operated gripping tool in the form of pliers 1. The uppermost (as viewed in the drawings) link member 5e is shown removed to reveal internal parts of the pliers 1. In this embodiment, there is no fixed handle 3.

As illustrated in FIG. 12 the jaw units 2a, 2b are shown opened by applying an axial force F to the support member 3a to move the fixed jaw unit away from the movable jaw unit 2b. The axial force F acts against the biasing force of the resilient member 8, which is held between respective spring posts 9 fixed to the jaw units 2a, 2b. When the axial force F is removed, the resilient member 8 pulls the jaw units 2a, 2b to lightly clamp a workpiece 11a between the jaw units.

Referring to FIG. 13, a force F applies a torque to the pivotal handle 4 to cause the cam 4a on the pivotal handle to act on the second clamp surface 3c via a slip shoe 17. This causes the movable jaw unit 2b to pivot on the cam surface 2c to provide a firm grip on the workpiece 11a.

The embodiments shown in FIGS. 5 to 8 have a fixed jaw unit 2a that is attached to a fixed handle 3 via an elongate support member 3a and a movable jaw unit 2b that is attached via one or more link members 5e to a pivotal handle 4 such that it can slide and pivot relative to the fixed jaw 2a. The support member 3a is an elongate bar with parallel oppositely facing clamp surfaces 3b, 3c, although, as shown in FIG. 4, the support member may taper towards the fixed jaw unit. With the pivotal handle 4 in the open position, the movable jaw unit 2 and pivotal handle 4 are free to slide to and fro along the support member 3a. There is an elongate slot 3d within the support member 3a containing a resilient member in the form of an extension spring 8 that has one end attached to the movable jaw unit 2b by a slide pin 7 and the other end attached to the fixed jaw unit 2a by a spring post 9a. The extension spring 8 acts to urge the two jaw units 2a, 2b towards a closed position. To open the jaw units 2a, 2b, the pivotal handle 4 is manually moved away from the fixed handle 3 and propelled along the elongate bar 3a to allow a workpiece 11 to enter between the jaw units 2a, 2b. Releasing the pivotal handle 4 allows the spring 8 to close the jaw units 2a, 2b on the workpiece 11. Manual activation of the pivotal handle 4 towards the fixed handle 3 then brings the cam 4a on the pivotal handle into contact with the second clamp surface 3c on the support member 3a to cause the movable jaw 2b to pivot on the cam surface 2c of the movable jaw unit 2b against the first clamp surface 3b. The pivotal handle 4 has a cam locking portion 2d that can be moved into engagement with the support member 3a at a location positioned above the cam surface 2c (i.e. nearer to the fixed jaw unit 2a). The grip between the jaw units 2a, 2b and the workpiece 11 is increased as the cam 4a is rotated against the second clamp surface 3c causing the movable jaw unit 2b to rotate towards the fixed jaw unit until the locking portion 2d comes into contact with the first clamp surface 3b. Provided the cam 4a on the pivotal handle 4 is suitably proportioned and has sufficient force exerted upon it by the actuation of the pivotal handle 4 towards the fixed handle 3, the workpiece 11 will be firmly clamped between the jaw units 2a, 2b. The degree of clamping action on the workpiece 11 will be directly related to the gripping action angle Ga or movable jaw 2b rotation on the cam surface 2c until the locking portion 2d is clamped against the first clamp surface 3b. In use, this can result in additional force being exerted outwardly upon the jaw units 2a, 2b. This force is a result of the geometry of the movable jaw unit 2b, cam surface 2c, locking portion 2d, cam 4a and the locking portion 4b and will correspondingly increase the clamping action upon the clamp surfaces 3b, 3c of the support member 3a. Given appropriate handles 3, 4, jaw unit 2a, 2b and cam 2c, 4a proportions, a ratio of over 12:1 handle to jaw closure leverage is achievable.

The pliers 1 can be manually operated by the operation of the pivotal handle 4 only. The grip on the workpiece 11 can be increased by manually increasing the force F applied between the pivotal and fixed handles 3, 4. The gripping function can be released by reversing the operating direction of the pivotal handle 4 (i.e. moving it away from the fixed handle 3) until gripping force of the jaw units 2a, 2b on the workpiece 11 is approximately that of the extension spring 8. This makes it possible to reposition the pliers on the workpiece in a manner similar to a ratchet wrench.

A further locking function can be incorporated in the pliers 1 by the provision of a generally flat locking portion or portions 4b adjacent to the cam 4a on the pivotal handle 4 such that movement of the cam 4a past the second clamp surface 3c brings the locking portion or portions 4b into engagement with the clamping surface. Provided the locking portion 4b engages the second clamp surface 3c past a point equivalent to a right angle from the clamp surface 3c through the center point of the pivot pin 6 (the cam lock distance D1), the jaw units 2a, 2b will remain locked on the workpiece 11 until the pivotal handle 4 is manually operated away from the fixed handle 3.

In some embodiments, in order to minimise the overall size of the pliers 1, the layout of the handles 3, 4 can be reversed, resulting in the cam 4a on the pivotal handle 4 acting upon the outer clamp surface 3c possibly causing the jaw units 2a, 2b to partially release their grip upon the workpiece 11. To overcome this potential problem, a slip shoe 17 can be provided. The slip shoe 17 can be retained within apertures in the link members 5e to ensure it is correctly positioned between the cam 4a and the second clamp surface 3c. In use the cam 4a then slips on the smooth surface of the slip shoe 17.

The embodiment shown in FIGS. 9 to 11 incorporates a pivotal link 12 between the fixed and movable handles 3, 4. A resilient member 8 pulls the pivotal link 12 to a position in which its movable end and the associated pivot pin 12a are at the end of the slot 3e in the fixed handle that is closest to the jaw units. This holds the jaws in the open position shown in FIG. 9. Initial operation of the handles 3, 4 from the position shown in FIG. 9 results in the pivotal handle 4 pivoting around the pivot link and pivot pin 12a, rapidly closing the jaw units 2a, 2b onto the workpiece 11 until the jaw units 2a, 2b abut the workpiece 11. Continued operation of the pivotal handle 4 forces the movable end of the pivotal link 12 and the associated pivot pin 12b along the slot 3e against the return force generated in the resilient member 8. This allows the pivotal handle 4 to rotate further towards the fixed handle 3. Moving the pivotal handle 4 towards the fixed handle 3 causes the cam 4a to act on the second clamp surface 3c. The movable jaw unit 2b then pivots on the cam surface 2c, further closing the jaw units 2a, 2b onto the workpiece 11 and ensuring the workpiece is sufficiently gripped prior to using the pliers on the workpiece.

As shown in FIGS. 12 and 13, a fixed handle 3 is not necessarily required, provided the resilient member 8 is strong enough to ensure closure of the jaw units 2a, 2b against a workpiece 11 during the initial actuation of the pivotal handle 4 until the cam 4a has sufficient grip on the second clamp surface 3c to allow movable jaw unit 2b to pivot on the cam surface 2c.

The geometrical proportions of the pliers 1 can be varied to suit many different applications and gripping forces.

It will be appreciated that conventional hand operated gripping tools are designed too rigid and strong and, in particular, the jaw units are not designed to flex away from the workpiece. By providing a designed weakening of one or both jaw units that actually promotes a limited bending away from the workpiece, and so away from the other jaw unit, it is possible to ensure that a locking function of the tool fully engages, even when the tool is being clamped onto a hard rigid workpiece. Thus a reliable clamping action can be achieved.

It will be appreciated that the or each jaw unit that is provided with a bend promoting portion should be made of a material (typically a steel) that is sufficiently resilient to cope with the bending without being permanently deformed or otherwise damaged by it.

Embodiments of the invention include a set of pliers for applying a torque to rotate fasteners, pipes/tubes and the like and especially for the operation of plumbing-type fittings. The pliers preferably include a locking function. Preferably, the locking function can be used to provide a ‘vice grip’ type clamping action that can be used for the purpose of gripping or clamping in a locking manner many differing shapes, materials or fasteners.

It will be appreciated that the gripping mechanism of the invention is not limited to pliers as shown in the embodiments. For example, the present invention could be advantageously applied to the clamping and locking mechanism of bar clamps used in such fields as carpentry.

1. A hand operated gripping tool comprising:
a first jaw unit having a workpiece engaging portion;
a second jaw unit having a workpiece engaging portion and being movable relative to said first jaw unit such that a variable size workpiece receiving space is defined between said workpiece engaging portions;
a handle for applying a force to said second jaw unit, said second jaw unit being engageable with a reaction surface such that, in use, in response to the force applied by said handle, the workpiece engaging portion thereof is forced against a workpiece received in said workpiece receiving space; and
an elongate extension portion extending from said workpiece engaging portion, said lever arm being connected with said elongate extension portion at a connection location and said extension portion having a bend promoting portion disposed between said workpiece engaging portion and said connection location which bend promoting portion is configured to promote limited bending of the extension portion in a direction away from said first jaw unit in response to a reaction force generated by engagement with the workpiece between said first and second jaw units.

2. A hand operated gripping tool as claimed in claim 1, wherein said bend promoting portion comprises a section that is bowed transverse to a lengthways direction of the extension portion.

3. A hand operated gripping tool as claimed in claim 2, wherein said extension portion comprises at least one planar member and said bowed section is bowed in a plane of the extension portion.

4. A hand operated gripping tool as claimed in claim 2, wherein said bowed section arches towards said first jaw unit.

5. A hand operated gripping tool as claimed in claim 1, wherein said bend promoting portion is disposed adjacent said reaction surface.

6. A hand operated gripping tool as claimed in claim 1, wherein said extension portion comprises two elongate members disposed in opposed spaced apart relation, each said elongate member comprising a respective bend promoting portion.

7. A hand operated gripping tool as claimed in claim 1, comprising a support member for said second jaw unit, said support member extending transversely with respect to said first jaw unit and said second jaw unit being slideable with respect to said first jaw unit on said support member for varying the size of said workpiece receiving space.

8. A hand operated gripping tool as claimed in claim 7, wherein said support member defines said reaction surface.

9. A hand operated gripping tool as claimed in claim 7, wherein said support member includes a first side surface facing into said workpiece receiving space and a second side surface disposed opposite and spaced from said first side surface, the spacing between said first and second side surfaces decreasing as said first and second side surfaces approach said first jaw unit.

10. A hand operated gripping tool as claimed in claim 8, comprising a camming device connected with said pivotal handle for causing said second jaw unit to engage said reaction surface.

11. A hand operated gripping tool as claimed in claim 1, further comprising an automatic locking device for locking said second jaw unit to fix the size of said workpiece receiving space, said automatic locking device comprising a locking member movable to a withdrawn non-operative position.

12. A hand operated gripping tool as claimed in claim 11, further comprising a biasing device arranged to bias said locking member to an operative position.

13. A hand operated gripping tool as claimed in claim 11, further comprising:
a fixed handle connected with said first jaw unit; and
a pivotal link pivotally connected to each said handle and provided with a slide pin that is slideable in a slot defined by one of said handle and said fixed handle.

14. A hand operated gripping tool as claimed in claim 13, wherein said locking member is engageable with said pivotal link for locking said second jaw unit.

15. A hand operated gripping tool as claimed in claim 14, wherein said locking member is provided with formations for cooperably engaging formations provided on said pivotal link.

16. A hand operated gripping tool comprising:
a first jaw unit;
a second jaw unit;
a first cam associated with said first jaw unit;
a pivotal handle for applying an operating force to said first jaw unit and a second cam associated with said pivotal handle; and
said first and second jaw units being cooperable to define a variable size space for receiving a workpiece and said first and second cams being operable in response to the operating force to cause said first and second jaw units to grip the workpiece that is positioned in said variable size space, at least one of said first and second jaw units comprising a flexure promoting portion configured to promote flexure of the jaw unit away from said variable size space in response to a reaction force generated by the workpiece when gripped between said first and second jaw units in said variable size space.

17. A hand operated gripping tool as claimed in claim 16, wherein said first jaw unit comprises a connection portion between said first cam and said pivotal handle and said flexure promoting portion is defined by said connection portion, said flexure promoting portion defining a fulcrum about which said first jaw unit can flex away from said variable size space.

18. A hand operated gripping tool as claimed in claim 16, wherein said second jaw unit comprises said flexure promoting portion, said flexure promoting portion comprising a recess provided in an outer side surface of said second jaw unit that faces away from said variable size space.

19. A hand operated gripping tool comprising:
a first jaw;
a second jaw cooperable with said first jaw to define a variable size workpiece receiving space;
a support on which said first jaw is slideable for varying the size of said workpiece receiving space; and
a pivotable lever, said first jaw and said pivotable lever each being provided with engagement portions for engaging respective parts on said support such that pivoting movement of said lever in one direction causes said first jaw to move against a workpiece that is positioned in said workpiece receiving space at least substantially in contact with said first and second jaws so as to grip the workpiece and said first jaw being configured to permit limited bending movement away from said workpiece receiving space in response to a reaction force generated by the workpiece when gripped between said first and second jaw unit in said workpiece receiving space.

20. A hand operated gripping tool as claimed in claim 19, wherein said engagement portions and said respective parts on said support are arranged such that, over a range of said pivoting movement in said one direction, said movement generates a progressively increasing gripping force on the workpiece received in said workpiece receiving space.

21. A hand operated gripping tool as claimed in claim 20, wherein at least one of said engagement portions is arranged to cooperate with the respective part on said support such that pivoting movement in said one direction beyond said range of said pivoting movement locks said first jaw in position against the workpiece received in said workpiece receiving space.

22. A hand operated gripping tool as claimed in claim 19, further comprising an automatic lock for locking said first jaw independently of engagement between said engagement portions and said respective parts on said support when said lever is moved in said one direction beyond a locking position.

23. A hand operated gripping tool as claimed in claim 22, wherein said automatic lock is selectively positionable in an inoperative position.

24. A hand operated gripping tool as claimed in claim 19, wherein said first jaw comprises corrugations for permitting said bending movement.

25. A hand operated gripping tool as claimed in claim 24, wherein said corrugations comprise at least one arch formed in said first jaw, said arch arching in the plane of the first jaw and generally towards said workpiece receiving space.
